(19) United States
(12) Patent Application Publication
(10) Pub. No.: US 2009/0167494 A1
(43) Pub. Date: Jul. 2, 2009

(54) Intelligent Power Cord Device ( iCord)

(76) Inventor: Carlos Eduardo Martins, (US)

Correspondence Address: Crossbar Technologies Corporation, 38736 Crane Terrace, Fremont, CA, 94536, US

(21) Appl. No.: 11/965,589

(22) Filed: Dec. 27, 2007

(51) Int. Cl. H04Q 5/22

(52) U.S. Cl. 340/10.1

(57) ABSTRACT

The iCord is an apparatus capable of controlling and/or monitoring the electrical power being fed to any device that uses detachable electric power cord. The iCord sits in between the power source and the electric load and contains, on one of its side, a power inlet, and on the other side, a power outlet. These two connectors are a complementary male/female pair matched to the respective connectors coming from the power source and going to the electric load. The iCord contains electronic circuit capable of switching its power outlet on/off based on controls sent wirelessly by a central module. The iCord may contain electronic circuit and sensors capable of measuring current being drawn through its outlet as well and voltage across its outlet terminals. A power control and monitoring network may be built by deploying many iCords wirelessly controlled by central module.

### FIELD OF INVENTION

The intelligent power cord device, referred throughout this document as iCord, is a detachable electrical power cord or adapter cord coupled to an intelligent electronic module. This intelligent electronic module built into the iCord, referred throughout this document as power module, is equipped with an electronic power switching and monitoring circuitry coupled to a wireless communication transceiver which enables remote controlling and monitoring of the electrical power passing through the iCord. In a typical application several iCords would be deployed in a certain location, powering up several electrical appliances or loads which would be remotely controlled and monitored by a central module, a concentrator and host of this set of distributed iCord devices. Each iCord receives electric power in and provides electric power out to an electrical load. The power module within the iCord is capable of switching electric power on or off and measuring parameters such as current, voltage, power and energy for each load connected to it. The power module may also probe, by means of built in sensors, environmental data such as temperature, humidity and barometric air pressure of the specific location where the iCord is installed. Below is a picture of a typical iCord device.

### INTRODUCTION

Power distribution units, or PDUs, provide a way to distribute power from a single input source to a plurality of power outlets. Additional to the basic concept of power distribution, some PDUs also have the capability of controlling and monitoring power parameters of each of these individual outlets. These PDUs are also known as intelligent power distribution units or IPDU. A typical use of IPDU is powering up a plurality of computer servers or any other appliances installed on data-center racks through a single connection to a building's wiring system. These equipments in the data-center environment and which need electrical power for their operation are commonly referred as loads.

The function of an IPDU can be replaced by the combination of several iCords attached to power outlets (or power strips) and a central module which allows each iCord to be individually and remotely controlled and monitored. The iCord will sit in between the original electric power cord and the load's power inlet. This strategic positioning of the iCord makes it possible to control, meaning switch the load on or off, and monitor, meaning measure the load's current flow, voltage, power, energy etc. This novel system deploying iCords and a central module and which replaces a conventional art IPDU is now referred as RCMPDS or Remote Controlled & Monitored Power Distribution System.

The wireless technology deployed on this invention provides great advantage over conventional IPDU technology since the iCords can now be distributed anywhere within the radio range of the central module whereas in a conventional deployment the loads need to be within close reach of IPDU due to limited cordage length. On a typical installation, it is just needed that the electric power cords from each load be unplugged (on the load's side) followed by insertion of iCords in between the original electric power cord and the load's electric power inlet receptacle. Some models of iCord optionally allow them to be inserted directly between the building's installation power outlet and the electrical appliance's power inlet.

### BRIEF DESCRIPTION OF DRAWINGS & PICTURES

Below are summarized descriptions of the drawings and pictures which are attached. Please refer to next section for detailed descriptions for these preferred but non-limiting examples:

Pic. 1 shows a type of iCord having an IEC320-C14 power inlet, the power block and an IEC320-C13 power outlet. This type of iCord is ideal to be used with electrical appliances or loads having an IEC320-C14 power inlet type;

Pic. 2 shows a type of iCord having an IEC320-C20 power inlet, the power block and an IEC320-C19 power outlet. This type of iCord is ideal to be used with electrical appliances or loads having an IEC320-C20 power inlet type;

Pic. 3 shows a type of iCord having an IEC320-C14 power inlet, the power block and an IEC320-C19 power outlet. This type of iCord is ideal to be used with electrical appliances or loads having an IEC320-C20 power inlet. This iCord perform additional function of cord adapter from cord type IEC320-C13 to cord type IEC320-C19;

Pic. 4 shows a type of iCord having an IEC320-C20 power inlet, the power block and an IEC320-C13 power outlet. This type of iCord is ideal to be used with electrical appliances or loads having an IEC320-C14 power inlet. This iCord perform additional function of cord adapter from cord type IEC320-C19 to cord type IEC320-C13;

Pic. 5 shows a type of iCord having a NEMA 5-15P power plug, the power block and an IEC320-C13 power outlet. This type of iCord is ideal to be used as direct power cord replacement for electrical appliances or loads having an IEC320-C14 power inlet type;

FIG. 1 shows a typical application of conventional IPDU where power coming from a single inlet is distributed to many outlets;

FIG. 2 shows an equivalent system as shown on FIG. 1 but this time using the novel concept of iCords deployed in a Remote Controlled & Monitored Power Distribution System, RCMPDS;

FIG. 3 shows a system where conventional IPDU system of FIG. 1 co-exists with novel concept RCMPDS of FIG. 2;

FIG. 4 shows a block diagram of the fully featured iCord;

FIG. 5 shows a similar block diagram as depicted on FIG. 4 where the environmental sensors where removed;

FIG. 6 shows a similar block diagram as depicted on FIG. 4 where the power monitoring sensors, i.e. current and voltage sensors, have been removed;

FIG. 7 shows a similar block diagram as depicted on FIG. 4 where the outlet is not switched;

FIG. 8 shows a similar block diagram as depicted on FIG. 7 where the environmental sensors where removed;

FIG. 9 shows a similar block diagram as depicted on FIG. 7 where the power monitoring sensors, i.e. current and voltage sensors, have been removed;

FIG. 10 shows a block diagram of the standalone central module;

FIG. 11 shows an optional topology for the central module comprised of generic computer plus an external radio adapter;

FIG. 12 shows a block diagram for the external radio adapter of FIG. 11.

FIG. 13 shows an optional topology for the central module comprised of generic network appliance plus internal radio adapter;

FIG. 14 shows a block diagram for the internal radio adapter of FIG. 13.

### DETAILED DESCRIPTION OF THE PRESENTLY PREFERRED EXEMPLARY EMBODIMENTS

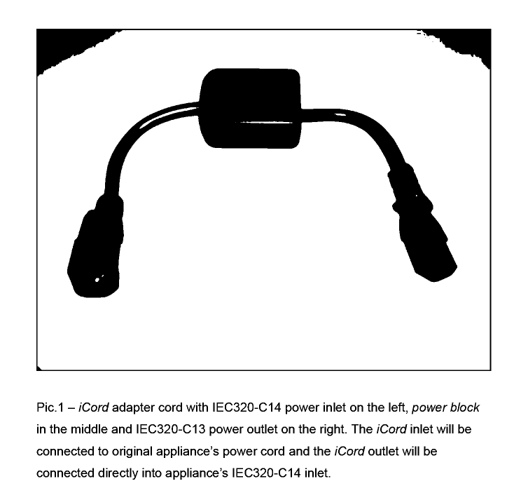

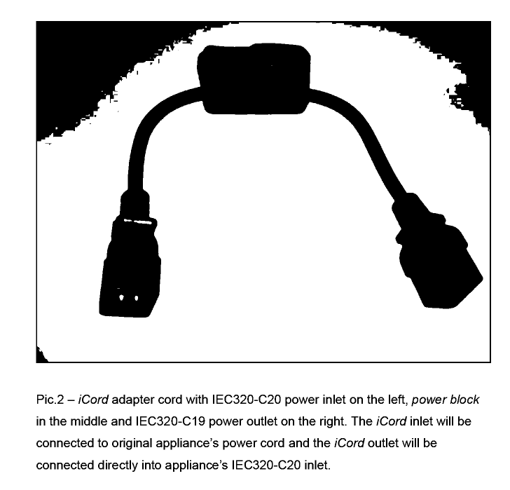

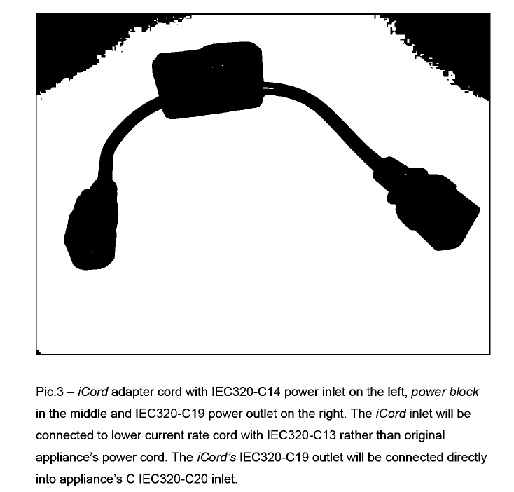

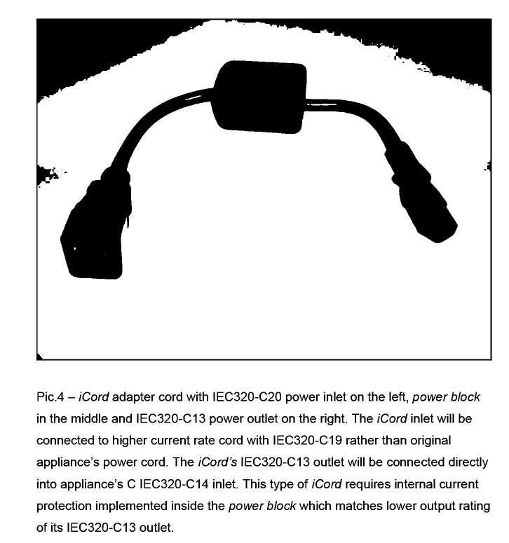

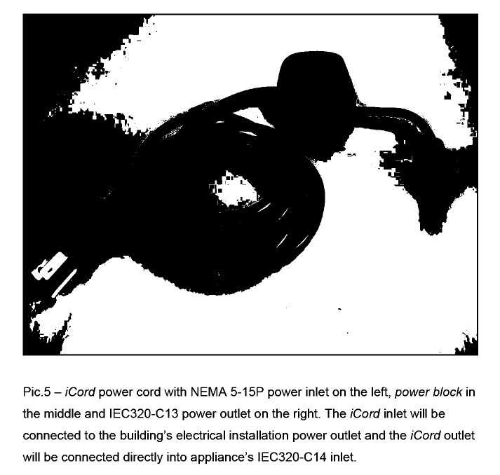

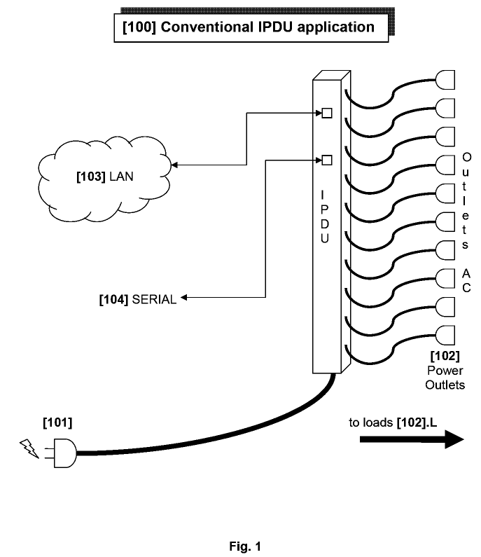

FIG. 1 shows an exemplary embodiment of an Intelligent Power Distribution unit, or IPDU 100, typically used in a data center environment. The IPDU 100 is used to distribute power coming from a single electrical power source 101 to a plurality of outlets 102 connected to servers, routers or any other IT appliances located within such environment, referred as loads 102.L. Sometimes the IPDU 100 also provides the capability to control each of its outlet's power state on or off, this way providing switched outlets capabilities. Also some IPDU 100 can provide the means to monitor electrical parameters such as current, voltage, and therefore derivate power and energy consumption of such loads. An additional optional feature of IPDU 100 is to monitor some environmental parameters of the location where it is being installed. Most common environmental parameters to be measured are: temperature, humidity and barometric air pressure. The IPDU 100 connects itself to local area network 103, usually ETHERNET LAN and may also have an auxiliary port for point to point serial connectivity to other peripherals 104, usually RS232.

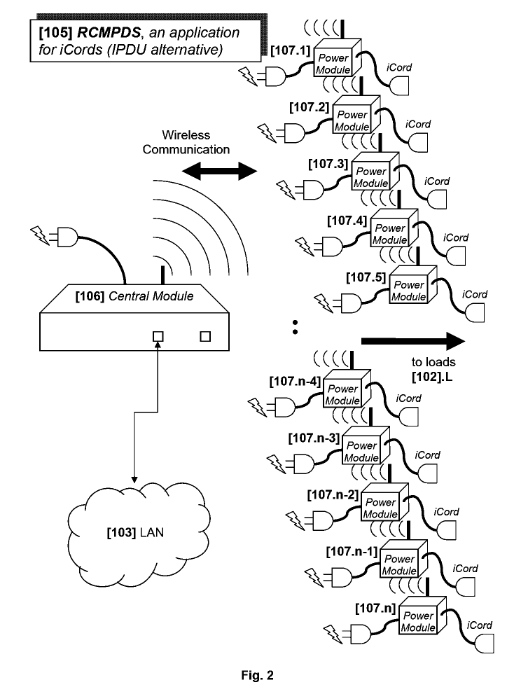

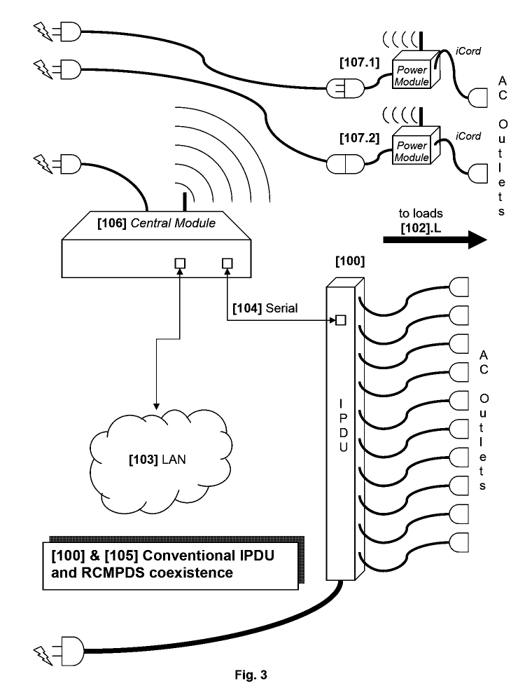

FIG. 2 shows an exemplary embodiment for typical RCMPDS 105 deploying iCords 107.1 to 107.n, the object of this invention. The RCMPDS 105 is a remotely controlled and monitored system for electric loads 102.L. Some types of electric loads 102.L on a data center environment, for instance, could be: computers, servers, routers, 14. The current sensor 110 can sense the analog current passing through its leads and is interfaced to MCU 115 by means of the analog to digital converter or ADC 111. Similarly a analog voltage sensor 112 can sense the analog voltage across the electric power rails coming from power inlet 101 and is interfaced to MCU 115 by means of the analog to digital converter or ADC 111. Environmental sensors can be also interfaced to MCU 115 by means of the analog to digital converter or ADC 111. Multiple channels are required for the ADC 113 which in this exemplary block diagram needs a minimum of 3 channels, 1 for current, 1 for voltage and 1 for environmental sensors. The gender of inlet 101 or outlet 102 are just exemplary, and may differ from the one depicted in this diagram in such a way that permits proper mating with incoming and outgoing electric circuits on the power source and load interfaces respectively.

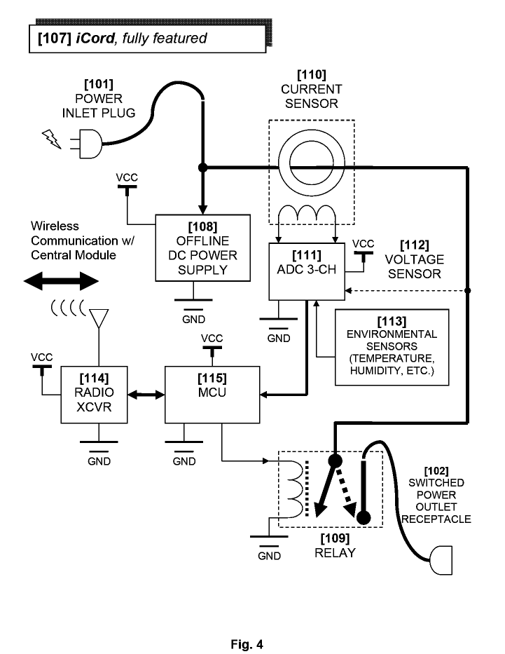

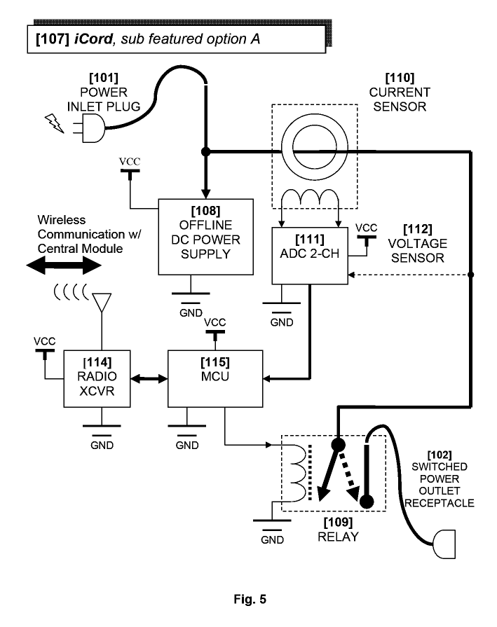

FIG. 5 shows an exemplary block diagram for an option of iCord 107 as described in FIG. 4, where the environmental sensors are non-existent from design or were removed by assembly option during manufacturing.

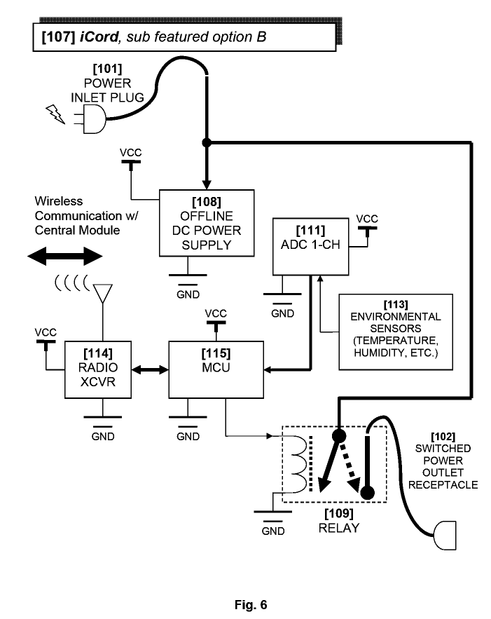

FIG. 6 shows an exemplary block diagram for an option of iCord 107 as described in FIG. 4, where the current and voltage sensors are non-existent from design or were removed by assembly option during manufacturing.

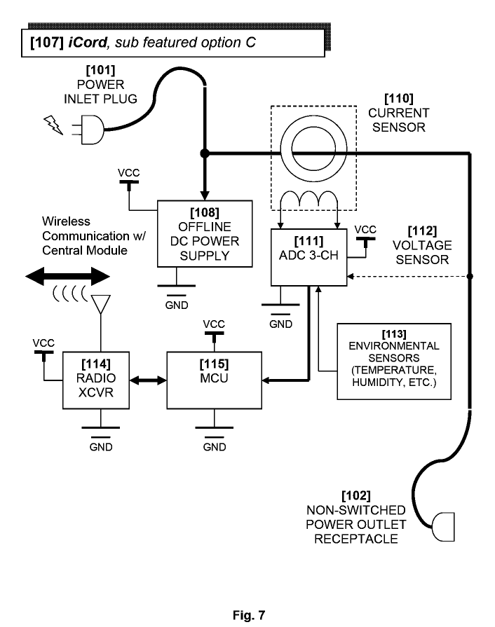

FIG. 7 shows an exemplary block diagram for an option of iCord 107 as described in FIG. 4, where the relay 109 is non-existent from design or was removed by assembly option during manufacturing. Therefore this version of iCord 107 has a non-switched power outlet 102.

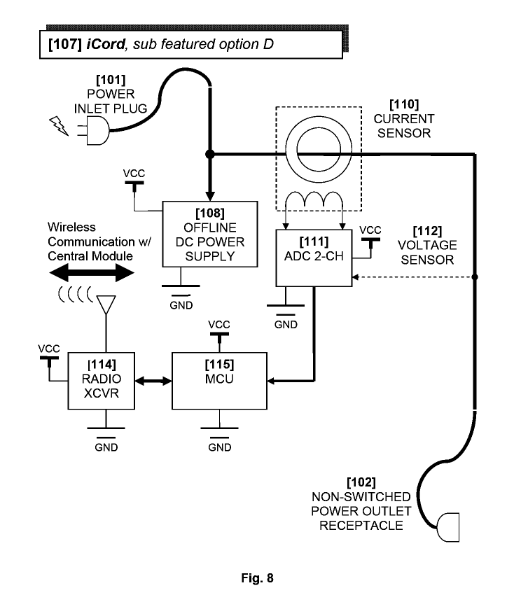

FIG. 8 shows an exemplary block diagram for an option of iCord 107 as described in FIG. 5, where the relay 109 is non-existent from design or was removed by assembly option during manufacturing. Therefore this version of iCord 107 has a non-switched power outlet 102.

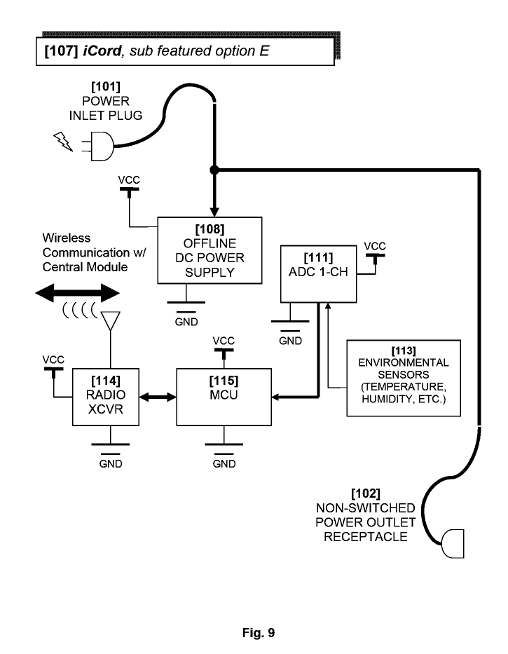

FIG. 9 shows an exemplary block diagram for an option of iCord 107 as described in FIG. 6, where the relay 109 is non-existent from design or was removed by assembly option during manufacturing. Therefore this version of iCord 107 has a non-switched power outlet 102.

FIG. 10 shows an exemplary block diagram for standalone central module 106. The device receives electric power on its power inlet 101 which is connected to offline DC power supply 108 that provides all required operating voltages for this appliance. The system revolves around a central processor 116 connected to RAM memory 117 and non-volatile memory 118. The system has two main communication paths. The first one is upstream, or the connection to the outside world: network or internet. This is usually provided by the Ethernet MAC/PHY interface provided by 119. The other communication path is downstream providing a path to the iCords 107. This downstream communication path is provided by the Radio Transceiver 114, which can use a point to multi point or a mesh topology in order to reach as many iCords 107 as necessary. The central module 106 provides the bridge between these two communications paths, allowing a remote user to fully control and query data out of each iCord 107. The other auxiliary communication path is provided by serial interface 120, usually RS232, which enables central module 106 to communicate point to point with other power management appliances, like a conventional IPDU.

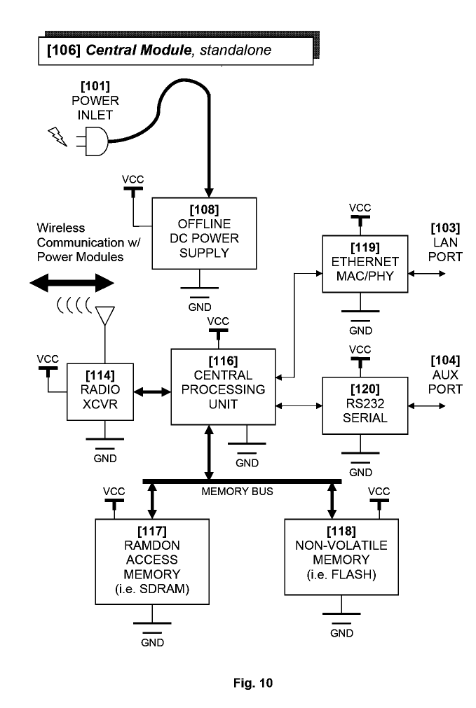

FIG. 11 shows an alternative implementation for central module 106 composed by a generic computer 121 connected to an external radio adapter 122. This external radio adapter 122 can be, for instance, connected to the USB port of the generic computer 121. Proper software running on generic computer 121 will emulate all the functions of a standalone central module 106 shown on FIG. 10. Note that the generic computer 121 is also connected to the local area network 103 and therefore can provide the same functionality as of standalone central module 106.

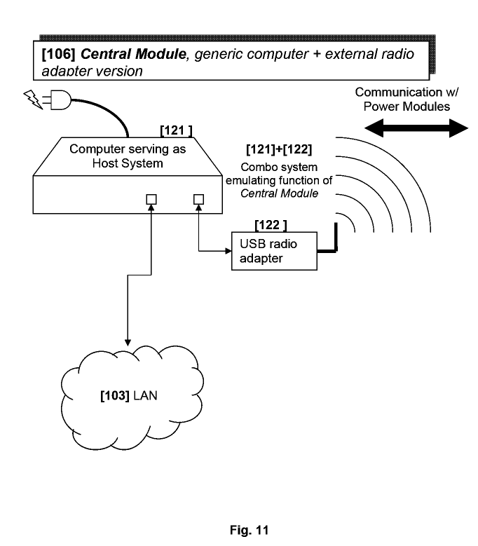

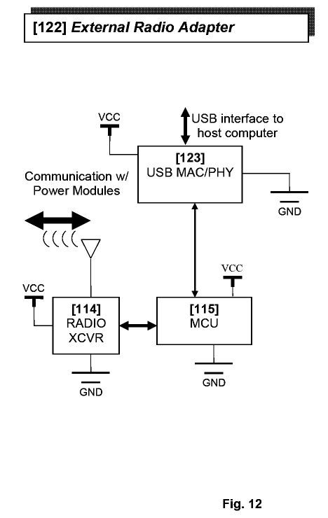

FIG. 12 shows a block diagram of the external USB radio adapter described on FIG. 11. Data from the generic computer is transferred to the MCU 115 by means of the USB Mac/Phy 123. The MCU 115 process all air protocol and, using radio transceiver 114, sends command to and query data from an undetermined number of iCords 107.

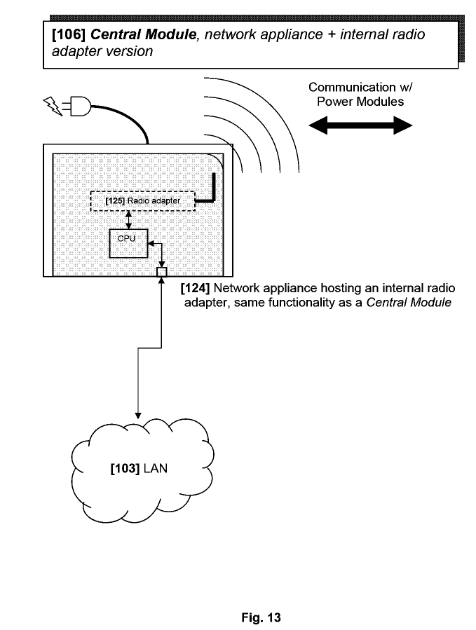

FIG. 13 shows an alternative implementation for central module 106 composed by a generic network appliance 124 connected to an internal radio adapter 125. This internal radio adapter 125 can be, for instance, connected to a serial interface header embedded into the generic network appliance 124. Proper software running on generic network appliance 124 will emulate all the functions of a standalone central module 106 shown on FIG. 10. Note that the network appliance 124 is also connected to the local area network 103 and therefore can provide the same functionality as of standalone central module 106.

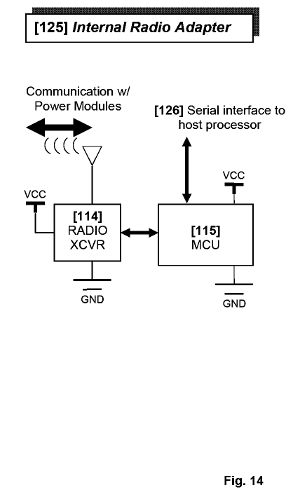

FIG. 14 shows a block diagram of the internal radio adapter described on FIG. 13. Data from the generic network appliance is transferred to the MCU 115 by means of the serial interface 126. The MCU 115 process all air protocol and, using radio transceiver 114, sends command to and query data from an undetermined number of iCords 107.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1) Intelligent Electric Power Cord device comprised of:
electric power inlet, which receives electric power from electrical power sources such as power outlets or power cords;
AC to DC power converter which derivates the electric power from the power inlet connector to be used by built in electronic circuitry;
power relay or switching device located inline between power inlet and power outlet that can turn the electric power outlet on or off based on commands received by built in radio transceiver;
electric power outlet intended to power up any load requiring electric power, which derivates its electric power from the electric power inlet passing through a power relay or switching device;
sensors that measure current, voltage, power and energy drawn by the power outlet;
environmental sensors that measure temperature, humidity and barometric air pressure;
radio transceiver that receives wireless commands to control power relay or switching device and send back status and data acquired from local sensors;
unique electronic ID tag that correlates specific target load being attached with the intelligent power cord device;

2) A variation of the unit of claim 1) which does not contain a power relay or switching device and therefore does not provide the capability to switch the power outlet off, just staying on permanently;

3) A variation of the unit of claim 1) or 2) which does not contain current or voltage sensors and therefore does not provide the capability to monitor current flow, voltage, power or energy;

4) A variation of the unit of claim 1) or 2) or 3) which does not contain environmental sensors and therefore does not provide the capability to monitor temperature, humidity and barometric air pressure;
